(19) United States
(12) Patent Application Publication
(10) Pub. No.: US 2011/0162023 A1
(43) Pub. Date: Jun. 30, 2011

(54) METHOD AND SYSTEM FOR PROVIDING CORRELATED ADVERTISEMENT FOR COMPLETE INTERNET ANYWHERE

(76) Inventors: Marcus Kellerman, San Diego, CA (US); Xuemin Chen, Rancho Santa Fe, CA (US); Vladimir Silyaev, Laguna Niguel, CA (US); David Erickson, San Clemente, CA (US)

(21) Appl. No.: 12/649,998

(22) Filed: Dec. 30, 2009

(51) Int. Cl. H04N 7/173

(52) U.S. Cl. 725/110

(57) ABSTRACT

A device (e.g., a server) retrieves a web page based on a request from another device, for example, a set-top-box (STB). The server determines advertising content and/or web page content to deliver to the STB. The server renders and/or encodes the advertising content and the web page content and communicates the content to the STB. The content is decoded and/or displayed by the STB. The advertising content may be determined based on television viewing, recording and/or web browsing via the STB. The advertising content may be determined based on location information and/or user information from a service provider the STB and/or from user input. Advertising may be inserted within a splash screen, a plug-in window, and/or an area within the web page. Web page advertising may be replaced, blocked and/or modified based on user information. The determined advertising may be communicated to the STB prior to communicating a plug-in.

### CROSS-REFERENCE TO RELATED APPLICATIONS/INCORPORATION BY REFERENCE

This application also makes reference to:

U.S. patent application Ser. No. ______ (Attorney Docket Number 22844US01) which was filed on ______;
U.S. patent application Ser. No. ______ (Attorney Docket Number 22845US01) which was filed on ______;
U.S. patent application Ser. No. ______ (Attorney Docket Number 22846US01) which was filed on ______;
U.S. patent application Ser. No. ______ (Attorney Docket Number 22847US01) which was filed on ______;
U.S. patent application Ser. No. ______ (Attorney Docket Number 22848US01) which was filed on ______;
U.S. patent application Ser. No. ______ (Attorney Docket Number 22849US01) which was filed on ______;
U.S. patent application Ser. No. ______ (Attorney Docket Number 22850US01) which was filed on ______; and
U.S. patent application Ser. No. ______ (Attorney Docket Number 22851US01) which was filed on ______;

Each of the above stated applications is hereby incorporated herein by reference in its entirety.

### FIELD OF THE INVENTION

Certain embodiments of the invention relate to communication systems. More specifically, certain embodiments of the invention relate to providing correlated advertisement for complete Internet anywhere.

### BACKGROUND OF THE INVENTION

With the continuous growth of on-line businesses, social networks, and other on-line services and applications, a user may want a larger number of places or locations from which to access the Internet in a manner that is flexible and/or suits the user's lifestyle. Most users currently connect to the Internet using a web browser running on a personal computer. While only a portion of homes have a computer, most homes have a television, and in many instances, multiple televisions. Therefore, rather than using a computer to access the Internet, a user may find it more convenient to use the flat screen televisions and/or monitors in homes for the same purpose. To do so, a set-top-box (STB) connected to, for example, a flat screen television may be provided with web browsing software and protocols, and Internet connectivity, which may enable the user to easily access the Internet or check their electronic mail (email), for example, from a convenient and comfortable location such as their living room.

There may be instances, however, in which the STB may not be configured to support and/or capable of processing certain content in a web page. Moreover, there may be instances in which the latency associated with rendering or displaying certain content in a web page may be long because of the processing capabilities of the STB. This may affect the overall experience of the user.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for providing correlated advertisement for complete Internet anywhere, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram that illustrates an exemplary home or office configured to access Internet services directly and/or indirectly via a set-top-box (STB), in accordance with an embodiment of the invention.

FIG. 1B is a diagram that illustrates another exemplary home or office configured to access Internet services directly and/or indirectly via an STB, in accordance with an embodiment of the invention.

FIG. 1C is a diagram that illustrates yet another exemplary home or office configured to access Internet services directly and/or indirectly via an STB using a switched digital video (SDV) scheme, in accordance with an embodiment of the invention.

FIG. 2 is a block diagram that illustrates an exemplary server that is operable to retrieve and adapt a web page for advertising to a particular audience or device, in accordance with an embodiment of the invention.

FIG. 3 is a block diagram that illustrates an exemplary set-top-box comprising a web browser that is operable to display web page advertising generated by a browser assisting server, in accordance with an embodiment of the invention.

FIG. 4 is a diagram that illustrates an exemplary web page with multiple content types that is to be displayed by a local web browser in an STB, in accordance with an embodiment of the invention.

FIG. 5 is a diagram that illustrates an exemplary web page comprising advertising content adapted for display via a web browser in a particular STB, in accordance with an embodiment of the invention.

FIG. 6 is a flow chart illustrating exemplary steps for adding, modifying and/or blocking content by a browser assisting server, in accordance with an embodiment of the invention.

### DETAILED DESCRIPTION OF THE INVENTION

Certain embodiments of the invention can be found in a method and system for providing correlated advertisement for complete Internet anywhere. In accordance with various embodiments of the invention, one or more processors and/or circuits in a device such as a server, for example, may retrieve content for a web page based on a request received from another device such as a set-top-box. The device may determine which advertising content and/or which of all or a portion of the web page content may be delivered to the other device. The device may render and/or encode the advertising content, and/or all or a portion of the web page content. The device may communicate the encoded advertising content and/or the web page content to the other device. The encoded advertising content and/or the web page content may be decoded and/or displayed by the other device, for example, the set-top-box.

The advertising content may be determined based on knowledge of television viewing, television selection activity and/or television recording events on the other device. The advertising content may be determined based on knowledge of browser activity and/or network and/or Internet content accessed via the other device. The advertising content may be determined based on knowledge about one or more users of the other device, for example, by an owner, operator and/or service provider of the device, or example, of a server and/or of the other device. The advertising content may be determined based on user preferences, user location, and/or input by a user of the other device and/or of the device. The advertising content may be inserted within the web page content at one or more of a splash screen, a plug-in window, a specified area within the web page content and/or an area above, below and/or to a side of content of the web page content. Advertising content received with the web page content may be replaced with the determined advertising content. Display of the advertising content received with the web page content may be blocked and/or modified based on knowledge about a user and/or based on activity on the other device and/or the device. The encoded advertising may be communicated to the other device, for example, the set-top-box prior to communicating a plug-in to the other device. In this manner, a set-top-box and/or another device, for example, a mobile phone may support Internet browsing with assistance from a local and/or a remote server, for example.

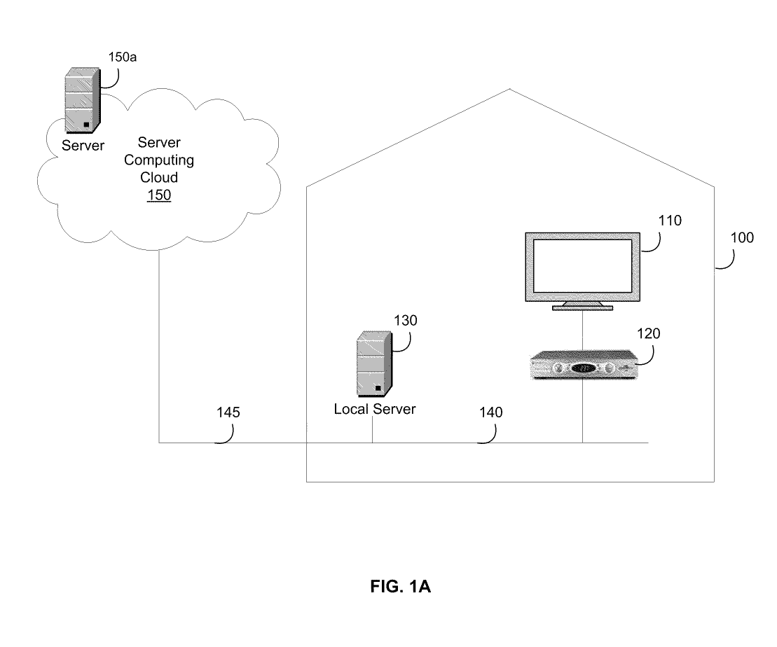

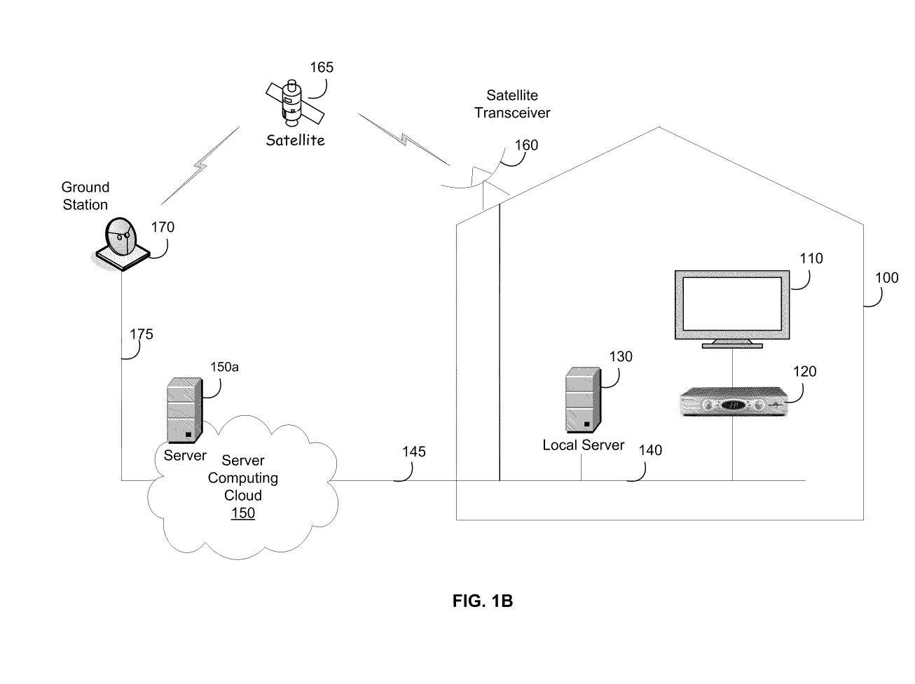

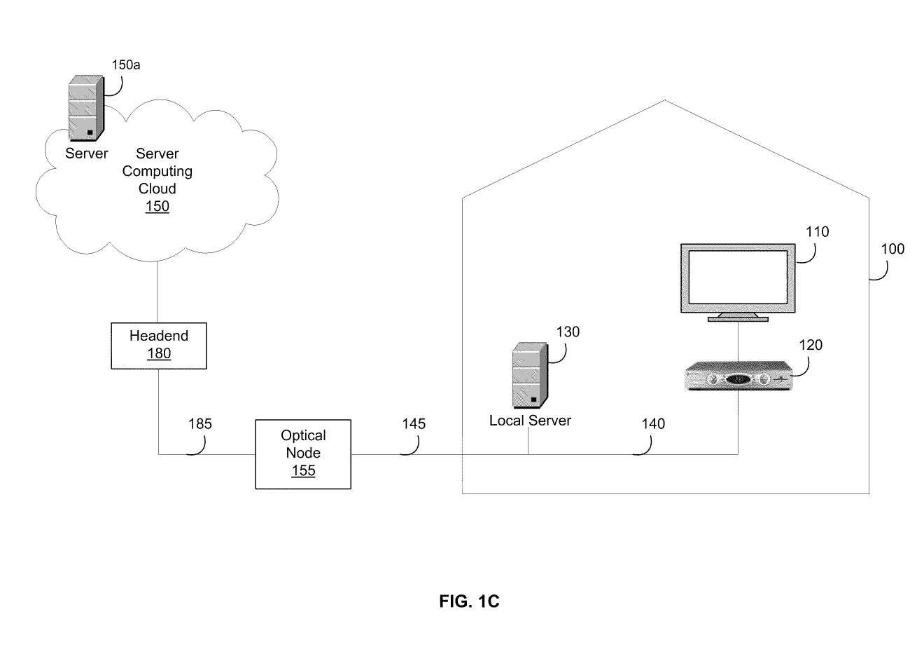

FIG. 1A is a diagram that illustrates an exemplary home or office configured to access Internet services directly and/or indirectly via a set-top-box (STB), in accordance with an embodiment of the invention. Referring to FIG. 1A, there is shown a location 100 within which may be disposed a television 110, an STB 120, a local server 130, and a broadband connection 140. Also shown in FIG. 1A is a computing cloud 150 comprising coupled to the location 100 via a broadband connection 145. The computing cloud 150 comprises a server 150a

The location 100 may be a home, a business, a school, a library, and/or other like setting in which a user may want to access the Internet and/or check their electronic mail (email). The position or placement of the television set 110, the STB 120, and/or the local server 130 within the location 100 may be based on user convenience and/or lifestyle. For example, when location 100 is a home (for example, a house, an apartment), the television 110 and the STB 120 may be located in a bedroom, a family room, or an entertainment room. In another example, when location 100 is a business or a public building, the television 110 and the STB 120 may be located in a conference room. The local server 130 may be located nearby (for example, in the same room) the television set 110 and the STB 120 or may be located remotely (for example, in another room or nearby building) from the television set 110 and the STB 120. In some embodiments of the invention, the broadband connection 140 may provide a wired connection that communicatively couples two or more devices within the location 100 utilizing a coaxial cable, for example. In other embodiments of the invention, in addition to wired connectivity, a portion of the broadband connection 140 may provide a wireless connection between two or more devices within the location 100.

The television 110 may comprise suitable logic, circuitry, code, and/or interfaces that may be operable to receive signals from which to display images (for example, moving images) that are typically accompanied by sound. The television 100 may be based on, for example, cathode ray tube (CRT) technology, plasma technology, liquid crystal display (LCD) technology, and/or light emitting diode (LED) backlit LCD technology. The television 110 may be operable to support one or multiple technical standards such as digital television (DTV) and high-definition television (HDTV), for example. The resolution of the screen or display portion of the television 110 may be based on the technical standard supported by the television 110. For example, for HDTV, the resolution of the screen may be 720p, 1080i, or 1080p, where the numeral indicates the vertical resolution of the screen, the letter “p” refers to progressive-scan format, and the letter “i” refers to interlaced-scan format.

The STB 120 may comprise suitable logic, circuitry, code, and/or interfaces that may be operable to connect the television 110 to an external source of signals and to convert those signals into content that may be displayed on the screen of the television 110. The STB may be operable to provide processing associated with managing, delivering, and/or storing video content that may be displayed on the television 110.

The STB 120 may also be operable to run a web browser that may be displayed on the screen of the television 110 for user interaction. A web browser is typically a software application that may enable a user to retrieve, present, or review information resources available on, for example, the World Wide Web (“the Web”). An information resource may comprise a web page, an image, video, text, graphics, and/or other type of multimedia content, for example. An information resource may also comprise an advertisement that may be displayed in a web page. The advertising content may be stored on the STB 120, on a server in the server computing cloud 150 and/or on the local server 130, for example. A web browser may also be utilized to access information that is provided by web servers in private networks and/or files in file systems. Examples of web browsers may comprise Internet Explorer, Mozilla Firefox, Apple Safari, Google Chrome, Opera, and/or browsers that may be native or custom-made for the STB 120.

Information resources are brought to the user via the web browser when the user inputs a Uniform Resource Identifier (URI) into the web browser. In this regard, the prefix of the URI may be utilized to determine how to interpret the URI. For example, a URI that starts with “http:” may identify a resource to be retrieved over Hypertext Transfer Protocol (HTTP). Other prefixes that may be supported include “https:” for HTTP Secure (HTTPS), “ftp:” for the File Transfer Protocol (FTP), and “file:” for local files, for example. A Uniform Resource Locator (URL) is typically a subset of the URI that specifies the location where an information resource is available for retrieval and/or the mechanism for retrieval.

Once the information resource has been retrieved, the web browser may be operable to display it. For example, HyperText Markup Language (HTML) may be passed to a layout engine in the web browser to be transformed from markup representation to an interactive document. In various instances, HTML may be utilized to represent advertising content. In addition to HTML, web browsers may display different types of content on a web page that may also comprise advertising content. For example, web browsers may display images, audio, video, and/or Extensible Markup Language (XML) files, and often comprise and/or support certain plug-ins for, for example, Flash applications and/or Java applets. In one embodiment of the invention, in instances when a file of an unsupported type or a file that is set up to be downloaded rather than displayed is encountered, the browser may prompt the user to save the file to fixed and/or removable memory storage, for example, a memory in the set-top-box. In another embodiment of the invention, the web browser may present one or more requests to the local server 130 and/or to a server in the server computing cloud 150, for example, the server 150a to assist with handling at least a portion of the unsupported content. Furthermore, in various exemplary embodiments of the invention, rather than retrieving information resources directly from web servers in private networks and/or in the Internet, the STB 120 may be operable to communicate the request to the local server 130 and/or to a server within the server computing cloud 150, for example, the server 150a which may retrieve the information resources for the STB 120. U.S. patent application Ser. No. ______ (Attorney Docket Number 22844US01) filed ______ on which is incorporated herein by reference in its entirety, discloses additional information regarding partial server processing. Also, U.S. patent application Ser. No. ______ (Attorney Docket Number 22845US01) filed on ______ which is incorporated herein by reference in its entirety, discloses additional information regarding full server processing.

The STB 120 may be operable to monitor, store and/or analyze various user and/or STB 120 information. For example, user information may comprise a user's activity when viewing, interacting with and/or recording television content and/or when accessing the Internet and/or a private network. For example, information regarding a user's channel and/or program selection may be monitored. Also, the STB 120 may be operable to monitor which web sites and/or Internet content a user selects. User information may comprise the location of the STB 120 and/or other information, for example, time of day that the STB 120 is utilized. The STB 120 may be operable to record input by a user and/or or service provider. For example, a user's preferences with regard to which content and/or which advertizing the user may wish to receive and/or may wish to block from receiving may be stored in the STB 120. In this regard, the STB 120 may provide an interface for a user to input preferences. The STB 120 may be operable to communicate user information to the local server 130 and/or to the server 150a, for example. The user information may be utilized to determine which content to deliver to the user. For example, advertising content may be selected and/or modified for display via a web browser on the television 110 based on a user's choices of content in television viewing, Internet access and/or a user's communicated preferences. Although advertisements may be communicated to the user, the invention is not so limited. Accordingly, other information, comprising for example, announcements, emergency information, server provider or other assistance information, news, weather, and/or other information may be communicated to the user.

The local server 130 may comprise suitable logic, circuitry, code, and/or interfaces that may be operable to run or execute certain software applications that may be accessible from the STB 120 via the broadband connection 140. In this regard, the local server 130 may be operable to provide support to the web browsing operations provided by the STB 120. The local server 130 may be implemented in a computing device, comprising for example a personal computer, laptop, tablet, or in a networking device, comprising for example, a router, which may provide processing capabilities that are sufficient for performing particular software applications. For example, in instances when the local server 130 is utilized to support web browsing operations in the STB 120, the processing capabilities in the local server 130 may be sufficient to run or execute software applications that provide such support.

The server computing cloud 150 may comprise a plurality of servers and/or computing devices associated with providing various services offered by the Internet. In this regard, the term ‘cloud’ typically refers to the Internet and is based on the graphical depiction of the Internet as a cloud in computer network diagrams to represent the underlying infrastructure of the Internet. The servers in the server computing cloud 150 may be utilized to provide reliable services that may be delivered through individual servers and/or data centers, for example. The server computing cloud 150 may appear, to a user or to a location (for example, location 100), as a single point of access to services and/or resources that may be provided by the server computing cloud 150. The servers in the server computing cloud 150 may comprise, for example, applications servers that may be dedicated to running certain software applications and/or web servers in which HTTP clients connect to send commands and receive responses along with data content.

A web server (not shown) in the server computing cloud 150, for example, may comprise suitable logic, circuitry, code, and/or interfaces that may be operable to deliver to a client (for example, the STB 120) web pages (for example, HTML documents) and associated content (for example, images, style sheets, JavaScripts). When a client requests a specific information resource using HTTP, the web server may respond by providing the content associated with that information resource. A full implementation of HTTP may enable the web server to receive content from a client.

A server 150a in the server computing cloud 150, such as an applications server, for example, may be utilized to support web browsing operations in the STB 120. In such instances, the server 150a in the server computing cloud 150 may have processing capabilities sufficient to run or execute software applications that provide such support. The server 150a may also be referred to as a render server or an STB assistance server, for example, to indicate that the server 150a may be operable to assist the STB 120 to render web content. Whether the server 150a in the server computing cloud 150 or the local server 130 is utilized to support web browsing operations in the STB 120 may depend, at least in part, on the amount of latency that may be acceptable to a user when having web browsing operations in the STB 120, such as the rendering of a web page, for example, be supported or assisted by another resource. In this regard, a local resource (for example, the local server 130) may have lower latency than a remote resource (for example, the server 150a in server computing cloud 150). Whether the server 150a in the server computing cloud 150 or the local server 130 is utilized to support web browsing operations in the STB 120 may also depend on, for example, availability of the local server 130, available resources on the local server 130, and/or the processing capabilities and the type of support that may be provided. The server 150a need not be physically collocated with a web server. The server 150a may be in different location from the web server.

The server computing cloud 150 may connect to the location 100 via a broadband connection 145. The broadband connection 145 may provide a wired connection between the server computing cloud 150 and the broadband connection 140 in the location 100 utilizing a coaxial cable, for example. Other embodiments, however, need not be so limited. For example, the broadband connection 145 may comprise a combination of wired and wireless portions, wherein the wired portion may utilize coaxial cables, optical fibers, and/or other large bandwidth transmission medium.

The local server 130 and/or a server within the server computing cloud 150, for example, the server 150a, may be operable to gather data regarding a user's activity, selections and/or interests. For example, the local server 130 and/or the server 150a may be operable to monitor, record and/or analyze a user's Internet access activity. In addition, the local server 130 and/or the server 150a may be operable to receive and/or record a user's preferences with regard to which content and/or which advertizing the user may wish to receive and/or may wish to block from receiving. In various embodiments of the invention, the local server 130 and/or the server 150a may be operable to receive user information from the STB 120. The local server 130 and/or the server 150a may be operable to determine which content, for example, advertising content to deliver to the user based on the user information. Furthermore, the content may be formatted for display on the television 110 via the STB 120. The advertising content may be communicated to the STB 120 by the local server 130 and/or by the server 150a. For example, advertisements may be selected and/or modified for one or more specific users and may be displayed by a web browser on the television 110 based on the users' activity, choices of content and/or the user's communicated preferences.

In operation, a user may decide to access a web page via a web browser in the STB 120 that is being displayed in the television 110 while comfortably sitting in his/her living room. The user may submit a URL to the web browser, which in turn may send a request for the information resource associated with that URL to a web server. The web server may pass the HTML and/or related content or information associated with the URL to the STB 120. In various embodiments of the invention, the STB 120 may perform a pre-fetch operation of the web page information provided by the web server to determine the type of content (for example, supported or unsupported content) that may be comprised within the web page and/or may be accessed via the web page. The STB 120 may be operable to perform the pre-fetch operation as a background process, for example.

The STB 120 may send one or more requests to a server that is operable to provide web browsing support to the STB 120. The STB 120 may request support for all or for portions of the web page content. In this regard, the STB 120 may send requests to the local server 130 and/or to a server in the server computing cloud 150, for example, the server 150a. The request may comprise information regarding the web page and/or information regarding what type of support may be needed from the server 150a. In various embodiments of the invention, the request may also comprise information that may be utilized for adding advertising content to the web page. For example, the STB 120 may provide user information to the server 150a. Advertising content may be stored in the server 150a and/or may be communicated from the STB 120 to the server. Once such information is received by the server 150a, the server may request and obtain appropriate web page content from the corresponding web server and may process the web page content. In addition, the server 150a may determine and/or generate advertising content that may be displayed with the web page content based on the user information. In this regard, the advertising content may be selected and/or modified for one or more users of the STB 120. The server 150a may encode the processed web page content and/or the advertising content into a format that may be received by the STB 120. In one exemplary embodiment of the invention, the processed content may be encoded with a low latency encoder protocol such as H.264/Advanced Audio Coding (ACC). In this regard, the server providing web browsing support to the STB 120, for example, the server 150a may be operable to transcode or provide direct conversion from one encoding format to another encoding format. In some embodiments of the invention, the transcoding may comprise changing the bitstream format of one file to another bitstream format without undergoing a decoding and re-encoding process.

The resulting audio and video (A/V) content produced at the server 150a may then be streamed to the STB 120. The STB 120 may decode the A/V stream and may render the resulting information, for example, as an entire web page and/or as an appropriate portion of the web page to composite the complete web page.

Although the STB 120 with a broadband connection capability is illustrated in FIG. 1A for full internet experience, the invention may not be so limited. Accordingly, instead of the STB 120, the television 110 itself with a broadband connection capability for full Internet experience may be supported without departing from the spirit and scope of various embodiments of the invention.

FIG. 1B is a diagram that illustrates another exemplary home or office configured to access Internet services directly and/or indirectly via an STB, in accordance with an embodiment of the invention. Referring to FIG. 1B, there is shown the location 100, the television 110, the STB 120, the local server 130, the broadband connections 140 and 145, the server computing cloud 150 and the server 150a described above with respect to FIG. 1A. Also shown in FIG. 1B are a ground station 170 communicatively coupled to the server computing cloud 150 via a broadband connection 175, a satellite 165, and a satellite receiver 160 coupled to the location 100. The satellite receiver 160 may be operable to communicate with the STB 120 via the broadband connection 140 in the location 100.

The ground station 170, the satellite 165, and the satellite receiver 160 may be operable to enable the STB 120 to communicate with a server in the server computing cloud 150, for example the server 150a, that may be operable to provide web browsing support to the STB 120 and/or with a web server from which web page information may be retrieved, for example. The ground station 170 and/or the satellite 165 shown in the location 100 are illustrated only as an exemplary configuration. Other configurations for the location 100 may be applied without departing from the scope of the present invention. For example, a different or the same configuration for the location 100 may be implemented to deliver television programs and/or broadband Internet to, for example, a vestigial sideband broadcast (VSB) off-air STB and/or a cable STB.

In operation, requests from the STB 120 to a remote resource (for example, the server 150a in the server computing cloud 150) for support in handling either portions of a web page or the entire web page may be communicated via the broadband connection 145 and/or via the wireless links associated with the ground station 170, the satellite 165, and the satellite receiver 160, and the broadband connection 175. Similarly, processed A/V content comprising advertising content selected for users of the STB 120 may be streamed from the remote resource and may be received by the STB 120 via the broadband connection 145 and/or via the wireless links associated with the ground station 170, the satellite 165, and the satellite transceiver 160.

FIG. 1C is a diagram that illustrates another exemplary home or office configured to access Internet services directly and/or indirectly via an STB using a switched digital video (SDV) scheme, in accordance with an embodiment of the invention. Referring to FIG. 1C, there is shown the location 100, the television 110, the STB 120, the local server 130, the broadband connections 140 and 145, the server computing cloud 150, and the server 150a described above with respect to FIG. 1A. Also shown in FIG. 1C, are a headend 180 communicatively coupled to the server computing cloud 150. Moreover, there is shown an optical node 155 in which one end is communicatively coupled to the headend 180 via a broadband connection 185 (for example, fiber optical link) and another end is communicatively coupled to the location 100 via the broadband connection 145 (for example, coaxial cable).

The headend 180, the broadband connection 185, and the optical node 155 may be utilized to provide a SDV scheme. In such a scheme, content for unwatched channels in a typical cable television system need not be sent and, thus, the available bandwidth may be increased. The unused channels in the broadband connection 185 may now be used by the STB 120 to communicate with a server in the server computing cloud 150, for example, the server 150a that may be operable to provide web browsing support to the STB 120. Since the channel may be dedicated to such communication between the STB 120 and the server, the web browsing support may be provided with low latency. In such an embodiment of the invention, utilizing a remote resource (for example, the server 150a) with large processing capabilities may be more suitable in certain circumstances than utilizing a local resource (for example, the local server 130) that may have more limited processing capabilities.

In operation, the STB 120 may utilize an unused broadcasting channel to establish a dedicated channel for communicating with a server in the server computing cloud 150, for example, the server 150a that provides web browsing support to the STB 120. Data comprising web page content and/or advertising content selected for users of the STB 120 may be communicated from the server 150a to the STB 120 through this dedicated channel. Once the support from the server 150a is no longer needed, the channel may be released from the headend 180 and may become available for the transmission of television programming, for example.

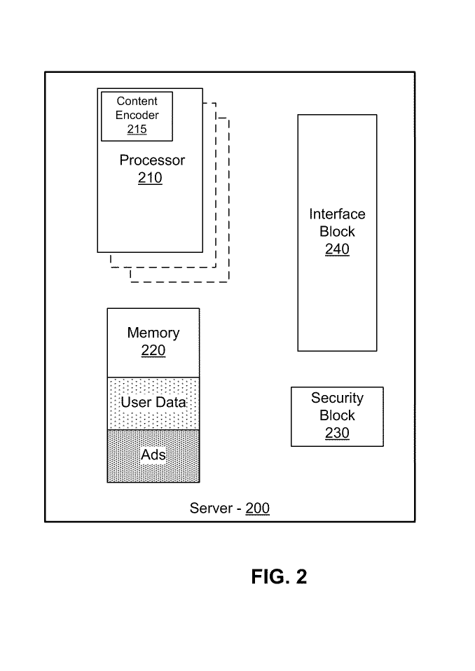

FIG. 2 is a block diagram that illustrates an exemplary server that is operable to retrieve and adapt a web page for advertising to a particular audience or device, in accordance with an embodiment of the invention. Referring to FIG. 2, there is shown a server 200 that may comprise a processor 210, a content encoder 215, a memory 220, a security block 230, and an interface block 240.

In some embodiments, the server 200 may correspond to the local server 130 and may be operable to provide web browsing support to the STB 120 as described above, for example. In other embodiments, the server 200 may correspond to a server in the server computing cloud 150, for example, the server 150a that may be operable to provide web browsing support to the STB 120 as described above. In various exemplary embodiments of the invention, the server 200 may be similar or substantially the same as the local server 130 and/or as a server in the server computing cloud 150, for example, the server 150a.

The content encoder 215 may comprise suitable logic, circuitry, interfaces and/or code that may be operable to transform data processed by the processor 210 into format supported by the STB 120.

The processor 210 may comprise suitable logic, circuitry, code, and/or interfaces that may be operable to process requests from the STB 120 to handle all or a portion of the content of a web page for subsequent rendering by the STB 120. In this regard, the processor 210 may be operable to convert and/or transcode content from one format into another format. For example, the processor 210 may be operable to process plug-ins unsupported by the web browser in the STB 120 and may encode such processed plug-ins with a low latency H.264/ACC encoder. The processor 210 may comprise a plurality of different encoders that may be utilized to encode different types of content from a web page into different formats, for example. Moreover, in various embodiments of the invention, the processor 210 may be operable to determine content, for example, advertising content to insert into a web page and/or to block from a web page. For example, advertising content that may be stored in the server 200 may be added to a web page and/or may replace content within a web page. The advertising content may be selected and/or generated based on user information. For example, information regarding one or more users of the STB 120 and/or activity on the STB 120 may be utilized to determine which advertising content may be inserted into a web page. The users of the STB 120 may provide preferences and/or other information, for example, parental control information, interests or content selections. The STB 120 may gather and/or record user activity on the STB 120, for example, television programming selections and/or Internet access activity.

In various embodiments of the invention, the STB 120 may communicate the user information to the server 200. The server 200 may also gather and/or record activity handled for the STB 120 and/or for the users of the STB 120, for example, Internet access activity. In instances when one or both of the server 200 and/or the STB 120 are owned, leased, operated and/or controlled by a service provider, for example, an Internet service provider (ISP) and/or a cable, a wireless and/or a satellite service provider, the service provider may have information about users that may be utilized to determine and/or generate advertizing content for display within and/or overlaid on, a web page on the STB 120.

In some embodiments of the invention, the processor 210 may comprise an x86-based architecture that may support processing of, for example, certain plug-ins developed or coded for execution in an x86-based processor architecture. In other embodiments, the server 200 may be operable to provide an emulator of the x86-based processor to process certain content unsupported by the STB 120.

The server 200 may comprise a plurality of processors 210, as indicated by the dashed outlines illustrated in FIG. 2. A single server 200 may be operable to support a plurality of STBs 120. In such instances, the server 200 may be operable to provide load balance and/or load sharing capabilities.

The memory 220 may comprise suitable logic, circuitry, code, and/or interfaces that may be operable to store information associated with the operation of the processor 210. The memory 220 may be operable to store information (for example, coefficients, tables) associated with the encoding operations supported by the processor 210. Furthermore, the memory 220 may be operable to store advertising content. The advertising content may be inserted within web pages that are handled by the server 200 for the STB 120 when the server 200 provides web browser support for the STB 120. In addition, the memory 220 may be operable to store user information. The user information may enable the STB 120 and/or the server 200 to correlate user information with advertising content stored within the memory 220. The user information may be utilized to determine which advertisements to deliver to the STB 120. The user information may be obtained in a plurality of ways and may be received by the server 200 from one or more of a plurality of sources. For example, a user and/or service person may input the user information or user preferences to the server 200 and/or to the STB 120, for example. In another example, the STB 120 may record and/or interpret activity in the STB 120, for example, which television programs are selected for viewing and/or which web sites or networks a user accesses. The STB 120 may communicate the user information to the server 200 and/or the information may be stored within the memory 220. The location of the STB 120 may also be stored within the memory 220, for example, as user information. Furthermore, the server 200 may be operable to gather user information and store it in the memory 220, for example, based on Internet activity the server handles for the STB 120. In this manner, the server 200 may be operable to determine which advertising content may be of interest or may be appropriate and/or effective for one or more users of the STB 120 based on user information.

The security block 230 may comprise suitable logic, circuitry, code, and/or interfaces that may be operable to support authentication operations, certificate usage, and/or cryptographic operations that may be utilized to provide secure connections between the server and the STB 120, for example.

The interface block 240 may comprise suitable logic, circuitry, code, and/or interfaces that may be operable to enable the server 200 to communicate with the STB 120 and/or with a web server from which to obtain web page information, for example. The interface block 240 may support a plurality of physical and/or logical connections or interfaces. When the server 200 corresponds to the local server 130 described above, the interface block 240 may support communication with the STB 120 via the broadband connection 140 (for example, coaxial cable).

In operation, the server 200 may receive a request from the STB 120 for web browsing support. The server 200 may receive a URL and/or information regarding which information to obtain from a corresponding information resource and/or user information, for example. The server 200 may obtain web page content from a corresponding web server and may process the entire web page content or a portion of the web page. The server 200 may utilize user information stored within the memory 220 and/or user information received from the STB 120 to determine which advertising content to communicate to the STB 120. The advertising content may be received from the STB 120 and/or may be stored within the memory 220. The advertising content may be processed for one or more users of the STB 120. Web page content and/or advertising content may be encoded into a format as A/V content that may be received and processed by the STB 120. The resulting A/V content produced at the server 200 may then be streamed to the STB 120. The STB 120 may decode the A/V stream and/or may composite the complete web page and advertising content.

In some embodiments of the invention, when the content that may need to be processed in the server 200 is secure content, the server 200 and the STB 120 may need to perform a two-way authentication operation before establishing a secure link between them and having the STB 120 share credentials with the server 200.

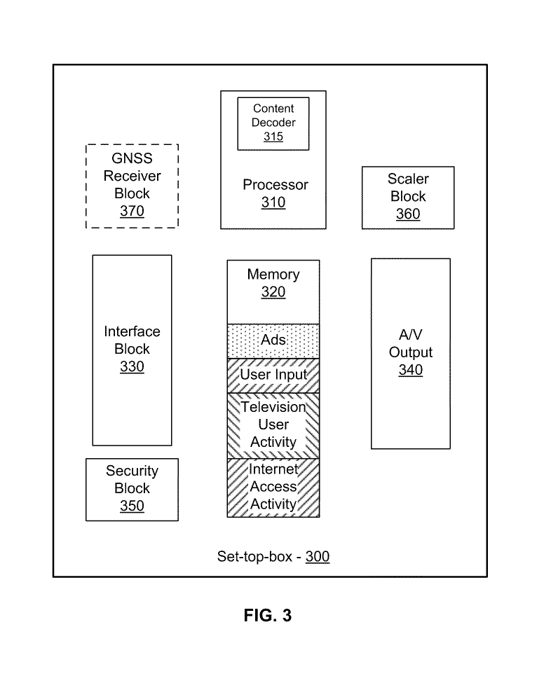

FIG. 3 is a block diagram that illustrates an exemplary set-top-box comprising a web browser that is operable to display web page advertising generated by a browser assisting server, in accordance with an embodiment of the invention. Referring to FIG. 3, there is shown a set-top-box (STB) 300 that may comprise a processor 310, a content decoder 315, a memory 320, a security block 350, an interface block 330, a scaler 360, an optional global navigation satellite system (GNSS) receiver, and an A/V output 340. In some embodiments, two or more of the components of the STB 300 may be integrated into a single chip.

The STB 300 may be similar and/or substantially the same as the STB 120. Although the STB 300 and/or the STB 120 may comprise exemplary embodiments of the invention, the invention is not limited in this regard and may comprise any kind of communication device that may utilize assistance from a server for decoding, processing, rendering and/or encoding data for display in a web page. For example, another exemplary embodiment of the invention may comprise a handheld device, a mobile phone, a media player, a gaming device and/or a location based services device that may receive browser assistance from the server 200.

The content decoder 315 may comprise suitable logic, circuitry, interfaces and/or code that may be operable to transform data encoded by the local server 130 or the server computing cloud 150 into a desired format for display.

The processor 310 may comprise suitable logic, circuitry, code, and/or interfaces that may be operable to provide processing associated with managing, delivering, and/or storing video content that may be displayed on, for example, the television 110 described above. The processor 310 may also be operable to run or execute a web browser that may be displayed on the screen of the television 110 for user interaction.

The processor 310 may be operable to perform a pre-fetch operation of web page information provided by a web server to determine the type of content that is comprised within and/or accessible via the web page. The processor 310 may be operable to perform the pre-fetch operation as a background process, for example.

The memory 320 may comprise suitable logic, circuitry, code, and/or interface that may be operable to store information associated with the operation of the processor 310. The memory 320 may be operable to store advertising content, for example, advertising content may be compressed and/or stored in the memory 320. When the STB 300 prepares to display a web page, the advertising content may be retrieved from the memory 320 and may be inserted within the web page content for display on the television 110, for example. Furthermore, the memory 320 may store information that may enable the STB 300 and/or the server 200 to correlate user information with various advertising content. The user information may be utilized to determine which advertisements to display with a web page and/or for users of the STB 300. The user information may be obtained in a plurality of ways. For example, a user may input information or content preferences. In addition, the STB 300 may record and/or interpret actions by one or more users. For example, the STB may store television program and/or content selections, and/or may monitor and record Internet access or interaction with a private network by a user. The location of a user and/or of the STB 300 may be provided by a user, a service provider and/or by a global navigation satellite system (GNSS) receiver within the STB 300. In various embodiments of the invention, the STB 300 may communicate the user information to the server 200. In this manner, the STB 300 and/or the server 200 may be operable to determine which content one or more users of the STB 300 may be interested in receiving. The STB 300 and/or the server 200 may determine which advertisements may be appropriate and/or effective for one or more users of the STB 300 based on the information stored in the memory 320.

The processor 310 may be operable to make one or more requests for handling either certain portions of a web page or an entire web page to a server that is operable to provide web browsing support to the STB 300. The requests may comprise user information and/or advertising content. The processor 310 may be operable to receive an A/V stream from such server comprising advertisement content adapted for users of the STB 300 and all or a portion of the web page content. If necessary, the processor 310 may composite a complete web page comprising the advertising content on the web browser.

In various embodiments of the invention, the processor 310 may be operable to read and/or interpret user information, for example, from the memory 320 and may determine which advertizing content to display on a web page based on the user information. Furthermore, the processor 310 may determine which advertising content to insert in a web page based on the content and/or source of the web page, for example.

In various embodiments of the invention, the STB 300 may not access the web page directly. The processor 310 may request that the server 200 fetch and/or render the entire web page and/or insert advertising for one or more users of the STB 300. The processor 310 may be operable to receive an A/V stream comprising the entire web page and/or the advertising content from the server 200 and may display the web page and/or advertising content on the web browser.

The security block 350 may comprise suitable logic, circuitry, code, and/or interfaces that may be operable to support authentication operations, certificate usage, and/or cryptographic operations that may be utilized to provide a secure connection between a server, which may be operable to provide web browsing support to the STB 300, and the STB 300, for example.

The interface block 330 may comprise suitable logic, circuitry, code, and/or interfaces that may enable the STB 330 to interface with a plurality of devices, comprising render servers and/or web servers. For example, the interface block 330 may support connections with cable TV services and/or satellite services. The interface block 330 may support multiple ports such as High-Definition Multimedia Interface (HDMI), Ethernet Physical Layer (PHY), Universal Serial Bus (USB), and RS232, for example. Other types of connections, protocols, and/or ports may also be supported.

The scaler 360 may comprise suitable logic, circuitry, code, and/or interfaces that may be operable to decode and/or convert content, for example, advertising content to be displayed with web page content. For example, the advertising content may be stored in the memory 320 and/or may be received from the server 200. In this regard, the web page content and/or the advertising content may be decoded by the scaler 360 to fit a specified area of the web page.

The A/V output 340 may comprise suitable logic, circuitry, code, and/or interfaces that may be operable to provide audio and/or video content for display or reproduction to, for example, the television 110 described above. In this regard, the A/V output 340 may support multiple technical standards such as DTV and HDTV, and/or multiple screen resolutions.

Although an STB with a broadband connection capability is illustrated in FIG. 3 for full Internet experience, the invention may not be so limited. Accordingly, other devices such as a television itself with a broadband connection capability for full Internet experience may be supported without departing from the spirit and scope of various embodiments of the invention.

In operation, a web browser may be run in the STB 300 and may be displayed in a television, for example television 110, via the A/V output 340. When a user interacts with the web browser, for example via a set-top-box remote control or keyboard, and submits a URL to the web browser, the STB 300 may send a request for the information resource associated with that URL to a web server via the interface block 330. The web server may pass the HTML and/or related content or information associated with the URL to the STB 300 via the interface block 330. The processor 310 may perform a pre-fetch operation of the web page information provided by the web server to determine the type of content that is comprised within the web page.

The processor 310 may send one or more requests to a server that is operable to provide web browsing support to the STB 300 via the interface block 330. The request may comprise information regarding the URL of the web page. Moreover, the request may comprise one or more of user information and/or advertising content from the memory 320. In response, the server may send an A/V stream comprising web page content and advertising content that may be selected and/or adapted for the user to the STB 300. The processor 310 in the STB 300 may decode the A/V stream and may render the resulting information to composite the complete web page and the advertising content.

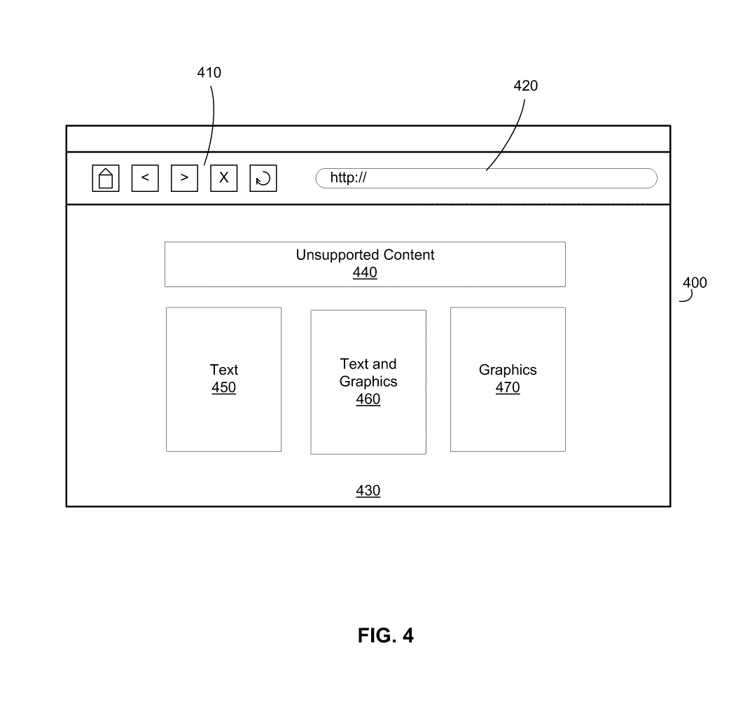

FIG. 4 is a diagram that illustrates an exemplary web page with multiple content types that is to be displayed by a local web browser in an STB, in accordance with an embodiment of the invention. Referring to FIG. 4, there is shown a web browser 400 in which a web page 430 is to be displayed or rendered. The web browser 400 may comprise certain user interface elements 410 (for example, back, forward, reload, stop, home) that may be utilized for navigation and/or operation, and an address bar 420 that may be utilized to submit a URI.

The web page 430 to be displayed in the web browser 400 may comprise different types of contents. In the example illustrated in FIG. 4, the web page 430 may comprise a text portion 450, a text and graphics portion 460, a graphics portion 470, and an unsupported (for example, plug-ins) portion 440. When a user selects the web page 430 content via the web browser 400, the STB may request assistance for processing the entire web page 430 from a server. Alternatively in instances when the STB performs a pre-fetch operation to determine the types of content in the web page, it may determine that the unsupported portion 440 may be a portion of the web page for which the STB may need support from a sever. In this regard, the STB may identify the unsupported portion 440 to a server via a request for assistance. The server may then process the entire web page 430 and/or only the unsupported portion 440 in accordance with the STB's request and may subsequently provide the processed content back to the STB in a format that the STB may utilize to composite the web page 430 in the web browser 400.

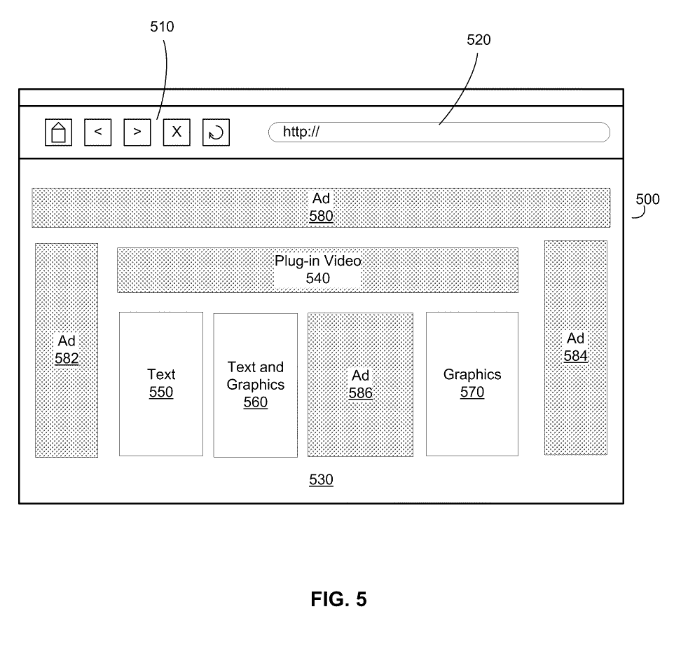

FIG. 5 is a diagram that illustrates an exemplary web page comprising advertising content adapted for display via a web browser in a particular STB, in accordance with an embodiment of the invention. Referring to FIG. 5, there is shown a web browser 500 in which a web page 530 is displayed or rendered. The web browser 500 may comprise certain user interface elements 510 (for example, back, forward, reload, stop, home) that may be utilized for navigation and/or operation, and an address bar 520 that may be utilized to submit a URI. In addition, there is shown a plurality of advertising content areas 580, 582, 584 and 586 within the web page 530.

The web page 530 may be similar to the web page 430, for example, the web page 530 may comprise a text portion 550, a text and graphics portion 560, a graphics portion 570, and a plug-in video portion 540. In addition, the web page 530 comprises the advertising content areas 580, 582, 584 and 586.

Advertising content for the advertising content areas 580, 582, 584 and 586 may be generated, selected, modified and/or blocked for a specified set-top-box for example, the STB 300 and/or for one or more specified users of the set-top-box. In an exemplary embodiment of the invention, the advertising content may be determined or chosen based on user information from a service provider, user input, user information stored in a server memory, such as the memory 220 and/or user information stored within the set-top-box memory, such as the memory 320. The advertising content in the content areas 580, 582, 584 and/or 586 may be generated by a server, for example, the local server 130 and/or a server in the server computing cloud 150, for example, the server 150a.

In various exemplary embodiments of the invention, advertising content or other content may be displayed at one or both sides of the web page 530, for example, as in the advertising content areas 582 and/or 584. The advertising content may be displayed across the top and/or the bottom of the web page 530, for example, as in the advertising content area 580. Furthermore, the advertising content may be displayed in various locations within the web page 530, for example, in the advertising content area 586. Furthermore, advertising content may be displayed in a plug-in area, for example, the advertising content may comprise video that may be displayed in the plug-in video portion 540. The plug-in area 540 may be utilized for static and/or motion advertising prior to displaying plug-in content from the web server, for example. Moreover, advertising and/or other content or information may be displayed as a splash screen prior to and/or during display of the web page 530. In various embodiments of the invention, advertising that may be received by the server with web page content from a web server, may be replaced by advertising content stored in the. Advertising from the server and/or a web server may be blocked based on user information, for example, based on user input.

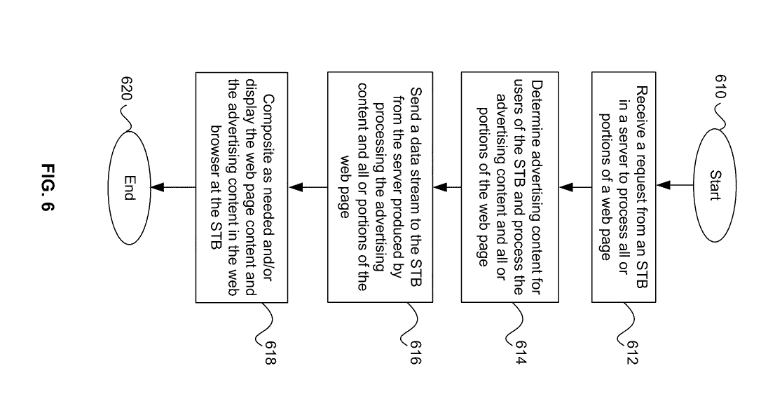

FIG. 6 is a flow chart illustrating exemplary steps for adding, modifying and/or blocking content by a browser assisting server, in accordance with an embodiment of the invention. The exemplary steps may begin at step 610. In step 612, the local server 130 and/or the server 150a, for example, may receive a request from the STB 120 to process all or portions of a web page, for example, the web page 530. In step 614, the local server 130 and/or the server 150a may determine advertising content for users of the STB 130n and may process the advertising content and all or portions of the web page 530. In step 616, a data stream may be sent to the STB 120 from the local server 130 and/or from the server 150a, that may be produced by processing the advertising content and all or portions of the web page 530. In step 618, the STB 120 may composite the web page 530 and/or the advertising content as needed and may display the web page 530 comprising one or more of the areas of advertisement, 540, 580, 582, 584 and 586 in the web browser at the STB 120. The exemplary steps may end at step 620.

In an embodiment of the invention, a device, for example, the local server 130, a server within the computing cloud 150, the server 150a and/or the server 200, may retrieve content for a web page based on a request received from another device, for example, received from the set-top-box (STB) 120 and/or the set-top-box 300. The server 150a, for example, may determine which advertising content and/or which of all or a portion of the content for the web page 530 may be delivered to the STB 120, for example. The server 150a may render and/or encode the advertising content and/or all or a portion of the content for the web page 530. The server 150a may communicate the encoded advertising content and/or the content for the web page 530 content to the STB 120. The encoded advertising content and/or the content for the web page 530 may be decoded and/or displayed by the STB 120. The advertising content may be determined based on knowledge of television viewing, television selection activity and/or television recording events on the STB 120. The advertising content may be determined based on knowledge of browser activity and/or network and/or Internet content accessed via the STB 120. The advertising content may be determined based on knowledge about one or more users of the STB 120, for example, by an owner, operator and/or service provider of the server 150a and/or of the STB 120. The advertising content may be determined based on user preferences, user location, and/or input by a user of the STB 120 and/or of the server 150a. The advertising content may be inserted within the content for the web page 530 at one or more of a splash screen, a plug-in window 540, a specified area within the web page 530, for example, the advertising content area 586 and/or an area above, below and/or to a side of content of the content for the web page 530, for example, the advertising areas 580, 582 and/or 584. Advertising content received with the content for web page 530 may be replaced with the determined advertising content. Display of the advertising content received with the content for web page 530 may be blocked and/or modified based on knowledge about a user and/or based on activity on the STB 120 and/or the server 150a. The encoded advertising may be communicated to the STB 120 prior to communicating a plug-in to the STB 120.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for providing correlated advertisement for complete Internet anywhere.

Accordingly, the present invention may be realized in hardware, software, or a combination of hardware and software. The present invention may be realized in a centralized fashion in at least one computer system or in a distributed fashion where different elements may be spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
performing by one or more processors and/or circuits in a device:
retrieving content for a web page based on a request received from a another device when said another device accesses said web page;
determining which advertising content and/or at least a portion of said content for said web page, to deliver to said another device;
encoding said determined advertising content, and/or said at least a portion of said content for said web page; and
communicating said encoded advertising content and/or said at least a portion of said content for said web page to said another device.

2. The method according to claim 1, comprising rendering said advertising content and/or said all or a portion of said content for said web page.

3. The method according to claim 1, wherein said another device comprises a set-top-box and/or said encoded advertising content and/or said all or a portion of said content for said web page is decoded and/or displayed by said another device.

4. The method according to claim 1, comprising determining said advertising content based on knowledge of one or more of television viewing activity, television content selection, television recording events, web browser activity, and/or network and/or Internet access activity on said another device.

5. The method according to claim 1, comprising determining said advertising content based on knowledge about one or more users of said another device by an owner, operator and/or service provider of said device and/or of said another device.

6. The method according to claim 1, comprising determining said advertising content based on user preferences, user location, and/or input by a user of said another device and/or of said device.

7. The method according to claim 1, comprising inserting said advertising content within said all or a portion of said content for said web page at one or more of a splash screen, a plug-in window, a specified area within said content for said web page and/or an area above, below and/or to a side of content of said content for said web page.

8. The method according to claim 1, comprising replacing advertising content received in said content for said web page with said determined advertising content.

9. The method according to claim 1, comprising blocking display of and/or modifying, advertising content received in said content for said web page based on knowledge about a user and/or based on activity on said another device and/or said device.

10. The method according to claim 1, comprising communicating said encoded advertising to said another device prior to communicating a plug-in to said another device.

11. A system for communication, the system comprising:
one or more processors and/or circuits for use in a device, wherein said one or more processors and/or circuits are operable to:
retrieve content for a web page based on a request received from a another device when said another device accesses said web page;
determine which advertising content and/or at least a portion of said content for said web page, to deliver to said another device;
encode said determined advertising content, and/or said at least a portion of said content for said web page; and
communicate said encoded advertising content and/or said at least a portion of said content for said web page to said another device.

12. The system according to claim 11, wherein said one or more processors and/or circuits are operable to render said advertising content and/or said all or a portion of said content for said web page.

13. The system according to claim 11, wherein said another device comprises a set-top-box and/or said encoded advertising content and/or said all or a portion of said content for said web page is decoded and/or displayed by said another device.

14. The system according to claim 11, wherein said one or more processors and/or circuits are operable to determine said advertising content based on knowledge of one or more of television viewing activity, television content selection, television recording events, web browser activity, and/or network and/or Internet access activity on said another device.

15. The system according to claim 11, wherein said one or more processors and/or circuits are operable to determine said advertising content based on knowledge about one or more users of said another device, by an owner, operator and/or service provider of said device and/or of said another device.

16. The system according to claim 11, wherein said one or more processors and/or circuits are operable to determine said advertising content based on user preferences, user location, and/or input by a user of said another device and/or of said device.

17. The system according to claim 11, wherein said one or more processors and/or circuits are operable to insert said advertising content within said all or a portion of said content for said web page at one or more of a splash screen, a plug-in window, a specified area within said content for said web page and/or an area above, below and/or to a side of said content for said web page.

18. The system according to claim 11, wherein said one or more processors and/or circuits are operable to replace advertising content received in said content for said web page with said determined advertising content.

19. The system according to claim 11, wherein said one or more processors and/or circuits are operable to block display of and/or modify, advertising content received in said content for said web page based on knowledge about a user and/or based on activity on said another device and/or said device.

20. The system according to claim 11, wherein said one or more processors and/or circuits are operable to communicate said encoded advertising prior to communicating a plug-in to said another device.
